(19) United States
(12) Patent Application Publication
(10) Pub. No.: US 2022/0098431 A1
(43) Pub. Date: Mar. 31, 2022

(54) CELLULOSE ESTER COMPOSITIONS FOR SURFACE COVERINGS

(71) Applicant: TARKETT GDL, LENTZWEILER (LU)

(72) Inventors: Pierre BASTIN, Lentzweiler (LU); Guillaume CHATTE, Lentzweiler (LU); Jean- Luc STIERNET, Lentzweiler (LU); Frédéric PAILLER, Lentzweiler (LU)

(21) Appl. No.: 17/426,372

(22) PCT Filed: Dec. 18, 2019
(86) PCT No.: PCT/EP2019/086103

§ 371 Date: Jul. 28, 2021

(30) Foreign Application Priority Data
Jan. 29, 2019 (EP) 19154331.3
May 20, 2019 (EP) 19175421.7

(51) Int. Cl. C09D 101/12; C09D 101/14; C08L 33/12; C08L 53/00; C08L 31/04; C08L 67/04; C08L 77/00; C08L 75/06; C08L 75/08; C08K 5/00; E04F 15/02

(52) U.S. Cl. CPC C09D 101/12; C09D 101/14; C08L 33/12; C08L 53/00; C08L 31/04; E04F 15/02; C08L 77/00; C08L 75/06; C08L 75/08; C08K 5/0016; C08K 5/0066; C08L 67/04

(57) ABSTRACT

The present invention discloses a surface covering, in particular floor or wall covering, comprising at least one polymer layer comprising a blend of polymers, said blend of polymers comprising from 6.5 to 93.5% by weight of a cellulose ester and from 93.5 to 6.5% by weight of one or more polymers selected from the group consisting of (meth)acrylate comprising (co)polymers, vinyl alkanoate comprising (co)polymers, vinylacetals (co)polymers, (co)polyesters, (co)polyamides, polyurethanes, nitrile (co)polymers, styrene (co)polymers, vinylchloride (co)polymers, olefin (co)polymers, and ionomers.

### FIELD OF THE INVENTION

The present invention is related to surface coverings, in particular a floor or wall coverings, comprising at least one polymer layer comprising a cellulose ester polymer.

### STATE OF THE ART

Synthetic flooring has gained widespread commercial acceptance and is made from various flooring compositions which may comprise all sorts of resins or mixtures of resins.

Flooring materials have to fulfil several technical criteria such as, for example, abrasion and scuff resistance, stain resistance, a good balance between hardness and flexibility, compatibility with additional adjuvants such as, for example, plasticizers, fillers, UV-stabilizers, pigments and colouring agents, flame retardants and antistatic agents, the possibility of its easily industrially processing, and an economically attractive raw materials cost.

Floorings such as tiles or rolls are made as mono-layer or multi-layer exhibiting different in-use properties.

A typical multi-layer flooring can contain, for example, seen from the bottom to the top, a core layer, a coloured and/or printed décor layer, a transparent wear layer and possibly an extra top-wear layer preferably a polyurethane-based coating. This flooring can optionally be combined with a form stabilizing element such as, for example a glass fiber mat and/or a backing layer.

A major component of many current synthetic flooring compositions is polyvinyl chloride (PVC) which can be applied in various forms such as, e.g. plasticized PVC and PVC foam. As a matter of fact, PVC is widely used in flooring materials.

For environmental and other reasons, there is an on-going effort to develop alternative adequate resin compositions for flooring.

Consequently, even though PVC offers excellent properties in its application for floor coverings, the manufacturers of these coverings have been looking for a substitute for it.

In light of the growing environmental awareness, it is advantageous to use biobased materials, not usable for food production, such as cellulose esters, as raw material(s) for flooring applications providing the flooring with desirable physical and mechanical properties.

Cellulose esters are in general obtained from reaction of a carboxylic acid and cellulose. Techniques for the preparation of cellulose esters are for example disclosed in U.S. Pat. Nos. 2,093,462; 2,093,464; 2,126,460; 2,196,768; 3,022,287 and WO 92/05219.

A commercial source of cellulose esters is Eastman Chemical Products, Inc., Kingsport, Tenn. Preferred cellulose esters include cellulose acetate, cellulose propionate, cellulose butyrate, cellulose acetate propionate, cellulose acetate butyrate, and cellulose propionate butyrate.

The introduction of cellulose ester in sheets and multilayer structures is subject to a limited number of patents.

WO 2018/017652 relates to calendared films or sheets comprising the cellulose ester compositions and processes for calendaring.

The cellulose ester composition comprises from 0 to 40% by weight, based on the total weight of the composition, of a plasticizer; from 0.1 to 2.0% by weight, based on the total weight of the composition, of a roll release agent; and from 0 to 6% by weight, based on the total weight of the composition, of a processing aid, said processing aid comprising an acrylic (co)polymer, a styrenic polymer, a carbonate polymer, a polyester polymer, an olefin polymer or a siloxane polymer.

US 2017/0259530 relates to an interlayer structure having a cellulose ester layer for use in structural laminates. The cellulose ester layer provides rigidity and support to multilayer interlayers comprising an array of different layers. The multilayer interlayer comprises:

a) a non-cellulose ester layer comprising a poly(vinyl acetal) resin or an ionomer resin;

b) a tie layer comprising a thermoplastic polymer resin selected from polyurethane resin or ethylene vinyl acetate resin; and

c) a cellulose ester layer comprising at least one cellulose ester having a hydroxyl content of at least 0.5 weight percent based on the entire weight of the cellulose ester, wherein said cellulose ester has a glass transition temperature of at least 50° C.,

wherein said tie layer is disposed between and in contact with the non-cellulose ester layer and said cellulose ester layer.

A key drawback of cellulose ester based layers is the so called curling, a phenomenon appearing in specific conditions of the “flooring” process.

### Aim of the Invention

The present invention aims to provide a cellulose ester based layer that does not present the prior art drawbacks

In particular, the present invention aims to provide a cellulose ester based mono- and multi-layer curling-free surface covering.

### SUMMARY OF THE INVENTION

The present invention discloses a surface covering in particular floor or wall covering, comprising at least one polymer layer comprising a blend of polymers A, said blend of polymers comprising from 6.5 to 93.5% by weight of one or more cellulose ester(s) (i) and from 93.5 to 6.5% by weight of one or more polymers selected from the group consisting of (meth)acrylate comprising (co)polymers (ii), vinyl alkanoate comprising (co)polymers (iii), vinylacetals (co)polymers (iv), (co)polyesters (v), (co)polyamides (vi) polyurethanes (vii), nitrile (co)polymers (viii), styrene (co)polymers (ix), vinylchloride (co)polymers (x), olefin (co)polymers (xi), and ionomers (xii).

Preferred embodiments of the present invention disclose on or more of the following features:
the cellulose ester (i) of the polymer blend A comprises:
   a plurality of C2-C5 alkanoyl substituents and
   a plurality of hydroxyl substituents
wherein the degree of substitution of the hydroxyl substituents is in the range of from 0.3 to 1.0;
the cellulose ester (i) of polymer blend A is selected from the group consisting of cellulose acetate, cellulose propionate, cellulose butyrate, cellulose acetate propionate and cellulose acetate butyrate;
the (meth)acrylate comprising polymers (ii) of the polymer blend A are selected from the group consisting of:
   (ii.a) the (meth)acrylate homo- or a random (co)polymer comprising at least 60% by weight, preferably at least 70% by weight, more preferably at least 80 parts by weight of methyl (meth)acrylate;
   (ii.b) the (meth)acrylate copolymer is a block copolymer comprising one or more blocks of methacrylic ester units and one or more blocks of acrylic ester units;
   (ii.c) the alkene/(meth)acrylate copolymer comprising from 50 to 95% by weight of one or more alkenes and from 5 to 50% by weight of one or more C1-C8 alkyl (meth)acrylates;
   (ii.d) the alkene/alkyl(meth)acrylate/carbon monoxide copolymers comprising from 40 to 80% by weight of one or more alkenes and from 5 to 60% by weight of one or more C1-C8 alkyl (meth)acrylates and 3 to 30% by weight of carbon monoxide; and
   (ii.e) mixtures of (ii.a), (ii.b), (ii.c) and (ii.d);
the vinyl alkanoate comprising polymers (iii) of the polymer blend A are selected from the group consisting of:
   (iii.a) the vinyl alkanoate homo- or copolymers comprising 60% by weight or more, preferably 70% or more, more preferably 80% or more, most preferably 90% or more of vinyl acetate;
   (iii.b) the alkene/vinyl alkanoate copolymers comprising 60% by weight or more, preferably 70% or more, more preferably 80% or more, most preferably 85% or more of vinyl alkanoate;
   (iii.c) the alkene/vinyl alkanoate/carbon monoxide copolymer comprising 40 to 80% by weight of one or more alkenes, 5 to 60% by weight of one or more vinyl alkanoates and 3 to 30% by weight of carbon monoxide; and
   (iii.d) mixtures of (iii.a), (iii.b) and (iii.c);
the polyester (v) is polylactic acid;
the vinyacetal (co)polymer (iv) is polyvinylbutyral;
the polyamide (vi) is an aliphatic polyamide;
the thermoplastic polyurethane (vii) is an aliphatic thermoplastic polyurethane comprising polyether and/or polyester segments;
the polymer layer, comprising polymer blend A, comprises up to 100 parts by weight of one or more plasticizers selected from the group consisting of dialkyl esters of cyclohexane dicarboxylic acids; dialkyl esters of aliphatic dicarboxylic acids; alkyl esters of mono- di-, tri-, or tetra-carboxylic acids; lower alkyl phosphates; lower alkyl-aryl phosphates; aryl phosphates; alkyl sulfonates; epoxidized or otherwise derivatized vegetable oils, citrate-based plasticizers and acetylated monoglycerides, for 100 parts by weight of polymer blend A;
the polymer layer, comprising polymer blend A, comprises from 0.01 to 3 parts by weight of an antioxidant, said antioxidant being a hindered phenol type antioxidant alone or a mixture of a hindered phenol type antioxidant and a phosphite type antioxidant, for 100 parts by weight of the polymer blend A;
the polymer layer, comprising polymer blend (A), comprises from 0.01 to 3 parts by weight of one or more light stabilizers selected from the group consisting of benzophenones, benzotriazoles, hydroxyphenyltriazines, cyanoacrylates, oxanilides and hindred amines;
the polymer layer, comprising polymer blend A, comprises from 0.2 to 40 parts by weight of one or more flame retardants selected from the group consisting of phosphorus comprising organic and inorganic flame retardants, halogenated flame retardants, halogenated phosphorus comprising organic flame retardants and mineral flame retardants, for 100 parts by weight of the polymer blend A;
the polymer layer, comprising polymer blend A, comprises up to 300 parts by weight of one or more organic and/or inorganic fillers selected from the group consisting of organic, inorganic, selected from the group consisting of coal fly ash, carbonate salts such as magnesium carbonate, calcium carbonate and calcium-magnesium carbonate, barium sulfate, calcium sulfate, magnesium sulfate, carbon black, metal oxides, inorganic material, natural material, alumina trihydrate, magnesium hydroxide, bauxite, talc, mica, dolomite, barite, kaolin, silica, post-consumer glass, or post-industrial glass, synthetic and natural fiber, for 100 parts by weight of the polymer blend A;
the polymer layer, comprising polymer blend A, comprises up to 10 parts by weight of one or more lubricants selected from the group consisting of the stearic acid type, the fatty acid ester type, the fatty acid amide type, the paraffin hydrocarbon type, the naphtenic hydrocarbon type, the metal soap type, the silicone type, polyethylene glycol type and waxes, for 100 parts by weight of the polymer blend A;
the surface covering comprises either:
   a wear layer forming the top layer;
   a printed layer in contact with the bottom surface of the wear layer;
   a core layer in contact with the bottom surface of the printed layer; and
   a backing layer in contact with the bottom surface of the core layer; or
   a wear layer forming the top layer;
   a printed layer in contact with the bottom surface of the wear layer; and
   a core layer in contact with the bottom surface of the printed layer;
wherein at least one of said backing-, core-, printed- and wear layer comprises polymer blend A;
the wear layer comprises polymer blend A;
at least one polymer layer comprises a glass-fiber mat or a non-woven characterized by an air permeability greater than 3000 l/m²·s, preferably comprised between 3000 and 15000 l/m²·s, and preferably comprised between 3500 and 10000 l/m²·s;
at least one layer comprises polymer blend A and wherein at least one other layer comprises one or more polymers selected from the group consisting of polyvinylchloride, copolymers of vinylchloride and other ethylenically unsaturated monomers, polylactic acid, polyvinylbutyral, styrene (co)polymers, (co)polymers of polyalkyleneterephthalate, (co)polymers of polyalkylenenaphthalate, (co)polyamide, polyurethane, polyolefin homopolymers, polyolefin copolymers and block copolymers comprising polymer blocks of one or more vinyl aromatic monomer(s) and polymer blocks of one or more alkylene(s).

The present invention further discloses a method for the preparation of the surface covering according to a process selected from the group consisting of calendaring, flat die extrusion, blown extrusion, heat press and combinations thereof.

### DETAILED DESCRIPTION OF THE INVENTION

The present invention provides a surface covering comprising at least one polymer layer, said polymer layer comprising a polymer blend A of one or more cellulose ester polymer(s) (i) and at least one non-cellulose ester polymer, said non-cellulose ester polymer being selected from the group consisting of (meth)acrylate comprising (co)polymer(s) (ii), vinyl alkanoate comprising (co)polymers (iii), vinylacetal (co)polymers (iv), (co)polyesters (v), (co)polyamides (vi), polyurethanes (vii), nitrile (co)polymers (viii), styrene (co)polymers (ix), vinylchloride (co)polymers (x) olefin (co)polymers (xi) and ionomers (xii).

The polymer layer comprising the polymer blend A according to the present invention comprises a blend of from 6.5 to 93.5% by weight of cellulose ester polymer (i) and of from 93.5 to 6.5% by weight of non-cellulose ester polymer (ii to xii).

The inventors have surprisingly found that a surface covering comprising one or more polymer layers comprising polymer blend A are free of curling upon their storage and use.

The cellulose ester polymer (i), used in polymer blend A comprises a plurality of (C₂₋₅) alkanoyl substituents chosen from acetyl, propanoyl, butyryl, isobutyryl, pivaloyl, pentanoyl or 3-methylbutanoyl. Preferably the (C₂₋₅) alkanoyl substituents are chosen from acetyl, propanoyl, butyryl.

Preferably the cellulose ester polymers comprise a plurality of (C₂₋₅) alkanoyl substituents and a plurality of hydroxyl substituents wherein the degree of substitution of the hydroxyl substituents is in the range of from 0.3 to 1.0, more preferably of from 0.4 to 0.9.

Preferably the cellulose ester polymer is selected from the group consisting of cellulose acetate, cellulose propionate, cellulose butyrate, cellulose acetate propionate, cellulose acetate butyrate and cellulose propionate butyrate.

The cellulose acetate polymers are characterized by a number average molecular weight (Mn) in the range of from 10.000 to 150.000, preferably in the range of from 10.000 to 100.000, more preferably in the range of from 10.000 to 80.000.

The (meth)acrylate comprising polymers (ii) for being used in the polymer blend A are selected from the group consisting of alkyl(meth)acrylate homopolymers and random copolymers (ii.a); alkyl(meth)acrylate block copolymers (ii.b); alkene/alkyl(meth)acrylate copolymers (ii.c); alkene/alkyl(meth)acrylate/carbon monoxide copolymers (ii.d) and mixtures thereof.

The alkyl(meth)acrylate (co)polymers (ii.a) comprise homopolymers of methyl methacrylate and/or random copolymers of methyl methacrylate and C₁ to C₈ alkyl (meth)acrylate, said C₁ to C₈ alkyl (meth)acrylates being selected from the group consisting of methyl (meth)acrylate, ethyl (meth)acrylate, n-propyl (meth)acrylate, n-butyl (meth)acrylate, i-butyl (meth)acrylate, n-hexyl (meth)acrylate, 2-ethylhexyl (meth)acrylate; said copolymers containing at least 60% by weight, preferably at least 70% by weight, more preferably at least 80 parts by weight of methyl methacrylate.

Poly(methyl methacrylate) (PMMA) is preferably used.

The alkyl (meth)acrylate block copolymers (ii.b) comprise from 10 to 90% by weight, preferably from 20 to 80% by weight of one or more block(s) comprising alkyl methacrylate monomers and from 90 to 10% by weight, preferably from 80 to 20% by weight of one or more blocks comprising alkyl acrylate monomers, wherein the alkyl methacrylates and the alkyl acrylates are those as defined in (iia).

Preferably the alkyl (meth)acrylate block copolymer is a di-block copolymer comprising a block comprising alkyl acrylate monomers and a block comprising alkyl methacrylate monomers such as for example a di-block copolymer comprising a block comprising n-butyl acrylate monomers and a block comprising methyl methacrylate monomers.

The alkyl (meth)acrylate copolymer more preferably is a tri-block copolymer comprising one block comprising alkyl acrylate monomers and two blocks comprising alkyl methacrylate monomers such as for example a tri-block copolymer comprising one block comprising n-butyl acrylate monomers and two blocks comprising methyl methacrylate monomers.

The alkene/alkyl(meth)acrylate copolymers (ii.c) comprise from 50 to 95% by weight of one alkenes and from 5 to 50% by weight of one or more C₁-C₈ alkyl (meth)acrylates wherein the one or more alkenes are defined by the general formula R₁R₂C═CR₃R₄, wherein R₁, R₂, R₃ and R₄ independently is a hydrogen or an alkyl radical containing from 1 to 4 carbon atoms and are preferably selected from the group consisting of ethene, propene, 1-butene, 1-pentene, 1-hexene, 2-methyl-1-butene, 2,3-dimethyl-1-pentene; and wherein the C₁-C₈ alkyl (meth)acrylates are selected from the group as defined in the alkyl(meth)acrylate (co)polymers (ii.a).

Preferably the alkene/alkyl(meth)acrylate copolymer is an ethylene/methylacrylate or an ethylene/butylacrylate copolymer.

The alkene/alkyl(meth)acrylate/carbon monoxide copolymers (ii.d) comprise from 40 to 80% by weight of one or more alkenes and from 5 to 60% by weight of one or more C₁-C₈ alkyl (meth)acrylates and from 3 to 30% by weight of carbon monoxide wherein the one or more alkenes and the one or more C₁-C₈ alkyl (meth)acrylates are selected from the group as defined in (ii.c).

Preferably the alkene/alkyl(meth)acrylate/carbon monoxide copolymer (ii.d) is an ethylene/ethyl acrylate/carbon monoxide, an ethylene/n-butyl acrylate/carbon monoxide or an ethylene/2-ethylhexyl acrylate/carbon monoxide copolymer.

The vinyl alkanoate comprising polymers (iii) for being used in polymer blend A are selected from the group consisting of vinyl alkanoate homo- and copolymers (iii.a), alkene/vinyl alkanoate copolymers (iii.b), alkene/vinyl alkanoate/carbon monoxide copolymers (iii.c) and mixtures thereof.

The vinyl alkanoate comprising homo- and copolymers (iii.a) comprise one or more vinyl alkanoate monomer(s), defined by the general formula RCOOCH═CH₂, wherein R is an alkyl radical containing from 1 to 20 carbon atoms, and are preferably selected from the group consisting of vinyl formate, vinyl acetate, vinyl propionate, vinyl butyrate, vinyl octanoate and vinyl stearate.

Preferably the vinyl alkanoate comprising copolymers (iii.a) comprise at least 60% by weight, more preferably at least 70% by weight, most preferably at least 80% by weight or even at least 90% by weight of vinyl acetate. Preferably the vinyl alkanoate polymer is polyvinyl acetate.

The alkene/vinyl alkanoate copolymers (iii.b) comprise one or more alkenes and one or more vinyl alkanoate(s) wherein the one or more alkenes are defined as in (ii.c) and wherein the one or more vinyl alkanoate monomer(s) are defined as in the vinyl alkanoate homo- and copolymers (iii.a).

Preferably the alkene/vinyl alkanoate copolymer (iii.b) comprises at least 60% by weight, more preferably at least 70% by weight, most preferably at least 80% by weight or even at least 85% by weight of one or more vinyl alkanoate(s) and 40% or less, preferably 30% or less, more preferably 20% or less, most preferably 15% or less of one or more 1-alkene(s).

Preferably the alkene/vinyl alkanoate copolymer (iii.b) is an ethylene/vinyl acetate copolymer comprising at least 60% by weight, preferably at least 70% by weight, more preferably at least 80% by weight, most preferably at least 85% by weight of vinyl acetate.

The alkene/vinyl alkanoate/carbon monoxide copolymers (iii.c) comprise 40 to 80% by weight of one or more alkenes, 5 to 60% by weight of one or more vinyl alkanoates and 3 to 30% by weight of carbon monoxide, wherein the one or more alkenes and the one or more vinyl alkanoates are defined as in the alkene/vinyl alkanoate copolymers (iii.b).

Preferably the alkene/vinyl alkanoate/carbon monoxide copolymer (iii.c) is an ethylene/vinyl acetate/carbon monoxide copolymer.

The vinylacetal (co)polymers (iv) for being used in polymer blend A of the present invention are selected from the group consisting of polyvinylbutyral, polyvinylethyral, polyvinylformal, polyvinylpropyral, and copolymers containing two or more different vinylacetal units such as poly(vinylethyral-vinylbutyral). Vinylacetal (co)polymers are always copolymers with vinyl alcohol units, since the reaction of polyvinyl alcohol to the full acetal is not complete, for statistical and steric reasons; in general the residual OH content is between 10 and 30% by weight.

Preferably the vinylacetal (co)polymer is polyvinyl butyral.

Polyvinyl butyral for being used in polymer blend A may be polyvinyl butyral which has not been used previously, but preferably is recovered or recycled, providing a lower cost but an equally high quality raw material. The kind of recovered or recycled polyvinyl butyral is not critical. It has been found that recovered or recycled polyvinyl butyral of different kinds and from different manufacturing origins, as well as mixtures of different kinds of polyvinyl butyral, are suitable for use in accordance to this invention.

The polyester (v) for being used in polymer blend A preferably is obtained from the condensation of one or more diol(s) such as ethylene glycol, 1,3-propanediol, 1,4-butanediol, or 1,4 cyclohexanedimethanol with one or more diacid(s) such as terephthalic acid, isophthalic acid, 2,6 naphthalenedicarboxylic acid, succinic acid, adipic acid, sebacic acid, fumaric acid or maleic acid, or from the condensation of an hydroxycarboxylic acid such as lactic acid. Optionally polyester (V) may comprise a blend of polyesters such as for example a blend of polyethylene terephthalate and polybutylene 2,6-naphthalenedicarboxylate.

Preferably the polyester (v) comprises polyethylene terephthalate or a copolyester thereof or polylactic acid.

Polylactic acid, refers to a thermoplastic polyester derived from 2-hydroxy lactate (lactic acid) or lactide (cyclic diester). The formula of the subunit is: —[O—CH(CH₃)—CO]—

The alpha-carbon of the monomer (CH₃CH(OH)CO₂H) is optically active, said monomer being produced by a fermentation method using a sugar extracted from maize, potatoes, or the like. Polylactic acid is typically selected from the group consisting of D-polylactic acid, L-polylactic acid, D,L-polylactic acid, meso-polylactic acid, and any combination thereof.

Polylactic acid in general is classified into crystalline polylactic acid and amorphous polylactic acid. The amorphous character increases as the racemic content increases. Typically polylactic acid, for being used in polymer blend A is an amorphous resin, possibly comprising some crystallinity,

The polyamide (vi) for being used in polymer blend A is selected from the group consisting of nylon 6, nylon 9, nylon 11, nylon 12, nylon 66, nylon 69, nylon 610, nylon 612, nylon 6/12, nylon 6/66, nylon 6/69, nylon 66/610, nylon 66/6, nylon 6T, nylon 12T, nylon MXD6, nylon MXD6/MXDI, nylon 6I/6T and blends thereof.

The polyurethane (vii), for being used in polymer blend A, contains hard and soft segments formed respectively of polymerized diisocyanate and polyol components. The ratio or weight % of hard to soft segments determines the physical properties of the thermoplastic polyurethane TPU.

The thermoplastic polyurethane is obtained from reaction of a diisocyanate compound with at least one difunctional compound capable of reacting with an isocyanate group, preferably at least one difunctional hydroxyl group comprising compound and optionally a chain extender.

Suitable chain extenders include aliphatic diol(s) such as 1,4-butanediol or 1,6-hexanediol; aminoalcohol(s) such as ethanolamine; and aliphatic diamines such as 1,6-hexamethylenediamine and isophoronediamine.

The difunctional compound capable of reacting with an isocyanate group preferably is a difunctional hydroxyl group comprising compound comprising a structure selected from the group consisting of polyesteramide, polythioether, polycarbonate, polyacetal, polyolefin, polysiloxane, polyesters, polyether, polycaprolactone and mixtures thereof.

Preferred difunctional hydroxyl group comprising compounds are polyesters, more particularly these obtained from the condensation of linear diacids and linear diols and polyethers, such as polytetraalkylene ether where alkylene is C₁ to C₄.

The diisocyanate compound may be aromatic or aliphatic. Aromatic diisocyanates include, for example, 4,4′-, 2,2′- and 2,4′-methylene diphenyl diisocyanate and toluene diisocyanate; aliphatic diisocyanates include, for example, 1,6-hexamethylene diisocyanate, isophorone diisocyanate and 2,2′-, 4,4′- and 2,4′-dicyclohexylmethane diisocyanate. Mixtures of aromatic and aliphatic diisocyanates may be used

Preferred isocyanates are methylene diphenyl diisocyanate and 4,4′-dicyclohexylmethane diisocyanate.

The thermoplastic polyurethanes preferably are characterized by a Shore A hardness of at least 30 and a Shore D hardness of 95 or less, as determined by ASTM D2240.

Examples of thermoplastic polyurethanes suitable for being used in the polymer blend A include Epamould (Epaflex Polyurethanes), Laripur (Coim S.p.A.), Apilon (Api Plastic S.p.A.), Estane and Pearlcoat/Pearlthane/Pearlbond (Lubrizol), Avalon (Huntsman Polyurethanes), Elastollan (BASF) and Pellethane (Dow Chemical Co).

The polyurethanes for being used in polymer blend A, may be a crosslinked polyurethane (thermoset).

The nitrile (co)polymers (viii) include those containing polymerized nitrile monomer and one or more polymerized monomers chosen from (meth)acrylate esters, vinyl esters, vinyl aromatics, vinyl amides, vinyl halides, alkenes and monomers including those having at least two vinyl groups per molecule such as allyl (meth)acrylate. Preferred nitrile monomers are acrylonitrile and methacrylonitrile and alpha-chloro acrylonitrile; most preferred is acrylonitrile.

The styrene (co)polymers (ix) include polystyrene and copolymers comprising polymerized styrene and one or more polymerized monomers chosen from alpha-methylstyrene, nitrile monomers, alkenes, alkylenes, alkyl(meth)acrylates or —N-phenylmaleimide.

Vinylchloride (co)polymers (x) include polyvinylchloride and copolymers containing polymerized vinylchloride and one or more polymerized monomers chosen from esters of unsaturated mono- or polycarboxylic acids, vinyl esters, vinyl aromatics, vinyl amides, or alkenes.

Olefin (co)polymers (xi) include C₂-C₈ homopolymers, C₂-C₈ olefin copolymers and C₂-C₈ copolymers comprising copolymerized monomers chosen from the group consisting of unsaturated mono- or polycarboxylic acids, vinyl acetate, vinyl alcohol, monovinylarene and mixtures thereof.

Ionomers (xii) include copolymers of alkene and unsaturated mono- or polycarboxylic acids; alkylene and unsaturated mono- or polycarboxylic acids, monovinylarene and unsaturated mono- or polycarboxylic acids wherein the cation is chosen from the alkali metals, alkaline earth metals, transition metals and ammonium.

The polymer blend A of the at least one polymer layer of the surface covering according to the present invention comprises:
from 6.5 to 93.5% by weight, preferably from 15 to 93.5% by weight, more preferably from 25 to 93.5% by weight; most preferably from 35 to 93.5% by weight or even from 45 to 93.5% by weight of cellulose ester polymer (i);
from 93.5 to 6.5% by weight, preferably from 85 to 6.5% by weight, more preferably from 75 to 6.5% by weight, most preferably from 65 to 6.5% by weight or even from 55 to 6.5% by weight of one or more non-cellulose ester polymer (ii to xii))

The composition of the at least one polymer layer of the present invention further comprises ingredients such as plasticizers, preferably bioplasticizers, and one or more additives, such as, modifying resins, thermal and light stabilizers, flame retardants, or any combination thereof.

Any plasticizer capable of plasticizing the composition comprising cellulose ester polymer (I) and non-cellulose ester polymer (II) can be used. Suitable plasticizers are selected from the group consisting of dialkyl esters of cyclohexane dicarboxylic acids; dialkyl esters of aliphatic dicarboxylic acids; alkyl esters of aromatic mono- di-, tri-, or tetra-carboxylic acids; lower alkyl citrates; lower alkyl phosphates; lower alkyl-aryl phosphates; aryl phosphates; alkyl sulfonates and other plasticizers used in conventional polyvinyl chloride applications.

Preferably the plasticizers comprise alkyl esters of polycarboxylic acids, more preferably alkyl esters of aromatic polycarboxylic acids.

Preferably the plasticizer is a dialkyl ester of poly(alkyleneglycol) such as for example triethylene glycol bis(2-ethylhexanoate).

Preferably the plasticizers comprise an epoxidized or otherwise derivatized vegetable oils, for example epoxidized soybean oils such as epoxidized C₁-C₁₀ alkyl soyate, epoxidized linseed oil, epoxidized soy oil, epoxidized tall oil and the like.

Preferably the plasticizer is an ecologically friendly citrate-based plasticizer that includes a blend of citrate and derivatized vegetable oil.

Preferably the plasticizer is an acetylated monoglycerides such as for example the acetylated monoglyceride of ricinoleic acid.

The plasticizer is typically present in an amount of up to 100 parts by weight, preferably from 2 to 100 parts by weight, more preferably from 3 to 70 parts by weight, most preferably from 4 to 55 parts by weight or even from 5 to 40 parts by weight, for 100 parts by weight of polymer blend A.

The composition of the at least one polymer layer of the present invention further comprise one or more antioxidants in an amount comprised between 0.01 to 3 parts by weight, preferably from 0.1 to 2 parts by weight, for 100 parts by weight of polymer blend A.

The antioxidant comprises one or more sterically hindered phenols or a mixture of one or more sterically hindered phenols and one or more phosphites.

The sterically hindered phenols, preferably are octadecyl-3-(3,5-di-t-butyl-4-hydroxyphenyl)propionate (Irganox® 1076); pentaerythritoltetrakis[3-(3,5-di-t-butyl-4-hydroxyphenyl)propionate] (Irganox® 1010) both supplied from BASF; and 4,4′-methylene-bis(2,6-di-t-butylphenol).

The phosphites preferably are trisnonylphenyl phosphite (Weston® TNPP) supplied from Addivant™; tris (2,4-di-t-butylphenyl)phosphite (Irgafos® 168) supplied from BASF, Ltd. and bis(2,4-di-t-butylphenylpentaerythritol) diphosphate (Everfos®-626) supplied from Everspring Chemical Co., Ltd.

The compositions of the at least one polymer layer of the present invention further comprise one or more light stabilizers in an amount comprised between 0.01 to 3 parts by weight, preferably from 0.1 to 2 parts by weight, for 100 parts by weight of polymer blend A. The light stabilizers are preferably chosen from benzophenones, such as Chimassorb® 81 FL; benzotriazoles, such Tinuvin® 326 FL and Tinuvin® 360; hydroxyphenyltriazines, such as Tinuvin® 1577 ED and Tinuvin® 600; cyanoacrylates such as Uvinul® 3030; oxanilides such as Tinuvin® 312 and hindred amines such as Chimassorb® 944 FLD and Tinuvin® PA 123, all supplied from BASF.

The polymer layer of the present invention further comprise from 0.2 to 40 parts by weight, for 100 parts of the polymer blend A of one or more flame retardants chosen from phosphorus comprising organic compounds, such as organophosphates, phosphonates and phosphinates; halogenated compounds; halogenated organophosphates and mineral flame retardants.

Examples of an organophosphate are triphenylphosphate or resorcinol bis(diphenylphosphate); an example of phosphonate is dimethyl methylphosphonate; an example of phosphinate is aluminum diethylphosphinate; examples of halogenated compounds are hexabromocyclododecane or polymeric/oligomeric brominated compounds; an example of halogenated organophosphorus compound is tris(1,3-dichloro-2-propyl)phosphate; examples of mineral compounds are magnesium hydroxide, aluminum hydroxide, zinc hydroxide; borates such as zinc borate and inorganic phosphorus compounds such as ammonium polyphosphate.

The at least one polymer layer of the surface coverings of the present invention further may comprise one or more lubricants of the stearic acid type, the fatty acid ester type, the fatty acid amide type, the paraffin hydrocarbon type, the naphtenic hydrocarbon type, the metal soap type, the silicone type, polyethylene glycol type and waxes, used alone or as a mixture. Preferred lubricants comprise a mixture of stearic acid type and silicone type lubricants.

Preferred lubricants are chosen from stearic acid and/or zinc stearate.

Preferred silicone type lubricants include siloxane homopolymers or copolymers comprising dimethylsiloxane units, methylhydrogen siloxane units, diphenylsiloxane units, phenylmethylsiloxane units, dimethylhydrogen siloxane units and trimethylsiloxane units. A preferred silicone is polydimethylsiloxane.

The polymer layer of the surface coverings of the present invention may comprise lubricants in an amount up to 10 parts by weight, preferably in an amount comprised between 0.5 and 5 parts by weight, more preferably between 1.5 and 4.5 parts by weight, most preferably between 2 and 4 parts by weight for 100 parts of polymer blend A.

The compositions of the at least one polymer layer of the present invention further comprise one or more fillers in an amount comprised between 50 and 500 parts by weight, preferably between 75 and 350 parts by weight, more preferably between 100 and 300 parts by weight for 100 parts by weight of polymer blend A.

Examples of fillers suitable for the composition of the present invention can be any conventional filler, especially those types traditionally used in surface coverings.

The filler can be organic, inorganic, or a combination of both, such as with different morphologies. Examples include, but are not limited to, coal fly ash, carbonate salts such as magnesium carbonate, calcium carbonate and calcium-magnesium carbonate, barium sulfate, carbon black, metal oxides, inorganic material, natural material, alumina trihydrate, magnesium hydroxide, bauxite, talc, mica, dolomite, barite, kaolin, silica, post-consumer glass, or post-industrial glass, synthetic and natural fiber, preferably cellulose fiber, or any combination thereof.

Preferably the filler comprises talc, mica, calcium carbonate, magnesium carbonate, dolomite, barite, bauxite, magnesium hydroxide, kaolin, silica, glass, or any combination thereof.

Preferably the filler comprises cellulose fiber.

Preferably, at least one polymer layer of the surface coverings of the present invention may include a carrier such as a woven or non-woven mesh or fabric, or tissue of more or less thermally stable materials such as glass fiber mat (GFM).

The carrier gives both strength and dimensional stability to the surface covering.

Advantageously the carrier comprises a glass-fiber mat and/or a non-woven characterized by an air permeability greater than 3000 l/m²·s, preferably comprised between 3000 and 15000 l/m²·s, and preferably comprised between 3500 and 10000 l/m²·s.

The polymer layer comprising the polymer blend A can be used as a monolayer surface covering but preferably is used as constituent of a multilayer surface covering.

Used as part of a multilayer surface covering, the polymer layer comprising polymer blend A can be combined either with halogen-free polymer layers comprising polymers chosen from the polymers (ii) to (xii), or with vinyl chloride (co)polymer(s) based layers, or with combinations thereof.

Preferably the polymer layer comprising polymer blend A is combined with halogen-free polymer layers, more preferably, the polymer layer comprising polymer blend A is combined with one or more polymer layers comprising polymers chosen from polymers (i) to (xii).

Preferably the polymer layer is part of a multilayer surface covering comprising a wear-, printed-, core- and backing layer each having a top surface and a bottom surface, wherein the top surface of the backing layer is affixed to the bottom surface of the core layer, wherein the top surface of the core layer is affixed to the bottom surface of the printed layer; wherein the top surface of the printed layer is affixed to the bottom layer of the wear layer and wherein the top surface of the wear layer is covered with a protecting top-coating.

Preferably the polymer layer, comprising polymer blend A, is the wear layer of the multilayer surface covering.

Used as wear layer, the polymer layer comprising polymer blend A may comprise a protecting top-coat on its top surface. This top coat is known to improve surface properties such as chemical resistance for instance.

The protecting top-coat is preferably obtained from standard polyurethane formulations such as two-component solvent borne, waterborne or solvent-free polyurethane formulations, solvent borne air drying or moisture curable one component formulations and aqueous polyurethane dispersions, wherein drying and/or cross-linking is performed at room temperature or higher eventually in combination with forced air conditions.

The protecting top-coat preferably is obtained from cross-linking under influence of actinic irradiation, of a radiation curable composition comprising ethylenically unsaturated polyurethane polymers and/or one or more ethylenically unsaturated oligomers and/or monomers, said oligomers and monomers comprising ester, ether and/or urethane group(s).

The radiation curable composition preferably comprises a radiation curable aqueous polyurethane dispersion.

The surface covering comprising at least one cellulose ester comprising polymer layer is prepared according to a process or a combination of processes well known in the art.

The hot polymer blend is prepared by compounding cellulose ester polymer (i) and non-cellulose ester polymer(s) (ii to xii) along with plasticizer(s), preferably bioplasticizers, lubricants, optionally filler(s) and one or more additives such as stabilizers, flame retardants and antistatic agents in a suitable heated mixer, for example in a twin screw or a single screw extruder, a mixing bowl with heated jacket, a Banbury mixer, continuous mixer, a ribbon mixer or any combination thereof at an internal temperature comprised between 150 and 240° C., preferable between 170 and 220° C., more preferable between 180 and 210° C. to form a blend.

Preferably the surface covering is obtained from a process selected from the group consisting of calendaring, flat die extrusion, blown extrusion, heat press and combinations thereof.

In general the calendaring process is used wherein a molten polymer blend is fed to a series of two or more heated rolls in such a way to produce a polymer layer of uniform thickness.

The multilayer structure preferably comprises a glass fiber mat.

Preferably multi-calendaring is performed in order to guarantee full impregnation of the glass fiber mat. Preferably the core layer comprises a glass fiber mat.

Calendaring is performed at:
a temperature comprised between 130 and 220° C., preferably between 150 and 210° C.;
a speed comprised between 2 and 100 m/min, preferably between 10 and 50 m/min.

The surface coverings comprising at least one polymer layer comprising polymer blend A, are free of curling and show excellent scuff resistance for the particular case where the polymer layer comprising polymer blend A is the wear layer.

Curling is measured at 23° C. and indicates the deviation, in millimeter, of the corners/edges of the surface covering from a completely flat configuration. A curling-free surface covering thus is characterized by a curling of less than 5 mm and preferably of 0 mm.

The inventors have demonstrated that for a surface covering characterized by curling values of 10 mm or less, said curling largely can be removed by optimizing the intrinsic stiffness of one or more layers or by optimizing the position of the glass fiber mat. Such optimization results in a reduction of curling values from less than 10 mm to less than 5, preferably to 0. For curling of 15 mm or more, the surface covering cannot sufficiently be improved and is unfit for being used.

The inventors further have surprisingly found that surface coverings comprising as wear layer, a polymer layer comprising the polymer blend A, wherein the cellulose ester polymer (i) is predominantly represented, are characterized by an outstanding scuff resistance, said scuff resistance being obtained with and without the application of a protective coating such as a radiation curable polyurethane coating.

The term “scuff resistance” is the ability of the wear surface to resist plastic flow when subjected to the force and frictional heat caused by the dragging of, for example, rubber or plastic soled shoes.

### Examples

The following illustrative examples are merely meant to exemplify the present invention and are not destined to limit or otherwise define the scope of the present invention.

The polymer layer comprising polymer blend A is used as wear layer in a multilayer surface covering with composition as in table 1

TABLE 1

| | PVC-based | Non PVC-based |
|---|---|---|
| Layer | Layer thickness | Layer thickness |
| Wear | Polymer Blend A | Polymer Blend A |
| | 0.5 mm | 0.5 mm |
| Printed | PVC | PVB/PLA/PMMA/TPU |
| | 0.15 mm | 0.15 mm |
| Core | High filled PVC | High filled recycled PVB |
| | 1.1 mm | 1.0 mm (GFM thickness |
| | | not included) |
| GFM | below the core layer | in the Core layer |
| | 0.35 mm | 0.35 mm |
| Backing | Medium filled PVC | PVB/PLA/PMMA/PVA |
| | 0.5 mm | 0.45 mm |

The inventors have observed that curling and scuff resistance are optimized independently on whether the polymer layer comprising polymer blend A is combined with either one or more layers comprising polymer blend A or with one or more layers not comprising polymer blend A or with one or more PVC-based layers.

The composition of polymer blend A is reproduced in table 2.

TABLE 2

| | | Examples | | | | | | | | | | | Comp. Ex. | |
|---|---|---|---|---|---|---|---|---|---|---|---|---|---|---|
| Polymer | | 1 | 2 | 3 | 4 | 5 | 6 | 7 | 8 | 9 | 10 | 11 | 12 | 13 |
| cellulose ester | (i) | 65 | 80 | 50 | 50 | 50 | 80 | 25 | 15 | 7 | 93.5 | 6.5 | 95 | 95 |
| (meth)acrylate | (ii) | 5 | 20 | | | | 6 | 35 | | 30 | 6.5 | 3 | 5 | 5 |
| (co)polymer | | | | | | | | | | | | | | |
| vinylalkanoate | (iii) | 30 | | | | 50 | 14 | | | | | | | |
| (co)polymer | | | | | | | | | | | | | | |
| vinylacetal | (iv) | | | | | | | 20 | | | | | | |
| (co)polymer | | | | | | | | | | | | | | |
| polyester | (v) | | | 50 | | | | | | 63 | | | | |
| polyamide | (vi) | | | | | | | 20 | | | | | | |
| polyurethane | (vii) | | | | 50 | | | | 85 | | | 90.5 | | |

| | | | | | | | | | | | | |
|---|---|---|---|---|---|---|---|---|---|---|---|---|
| plasticizer | 20 | 24 | 30 | 15 | 40 | 20 | | 15 | 30 | | 30 | 30 |
| lubricant | 1.3 | 1.3 | | | | | 2 | 2 | 1.5 | 2 | 1.3 | 1.3 |
| flame retardant | 24 | 24 | 10 | 15 | 25 | | | 15 | 25 | | 0 | |
| filler | | | | | 200 | | | | | | | |

In table 2, examples 1 to 11 are according to the invention and all show a curling from 0 to 5 mm; for example 1, 2 and 6 a scuff resistance of respectively 15, 14 and 13 is measured. Example 12 and 13 are given as comparative example, showing a curling of 50 mm for example 12 (based on cellulose acetate propionate) and 30 mm for example 13 (based on cellulose acetate butyrate), making the measurement of the scuff resistance impossible.

The inventors have observed that replacing the “polymer blend A” of the wear layer in table 1 with PVC, the PVC-based wear layer having a Shore A hardness of 95, results in a surface covering showing a curling of 0 mm and a scuff value of 6.

Curling is measured on panels with dimensions of 25×30 cm, standing at room temperature, said panels being laminated at a temperature in the range of from 150 to 160° C. for 90 seconds.

The scuff resistance is assessed using a friction test apparatus wherein an Astral rubber tool with thickness of 5 mm and a width of 0.8 mm, while subjected to a loading of “Y” kg is moved “X” times over 25 cm over the test area at a speed of 0.40 m/s.

In the test the rubber tool, before touching the test panel (39×39 cm) is moved over 2 cm of abrasive paper (P600)

The complete test consists of:

| “X” | “Y” |
|---|---|
| 6 | 9 |
| 4 | 7 |
| 2 | 5 |
| 1 | 4 |
| 1 | 3 |

After each test series (for example 6 times with a 9 kg loading) the test panel is visually evaluated on a 0 to 3 scale where:

0 results in severe damage

1 results in damage

2 results in slight damage

3 results in no visual damage

Finally the test result of the respective series are added together for a final result comprised between 0 and 15.

In table 2, the cellulose ester polymer (i) is cellulose acetate propionate CAP 482 20 for the examples 1, 2, 6, 7, 8, 9, 10 and 12; and cellulose acetate butyrate CAB 381 20 for examples 3, 4, 5, 11 and 13.

Further the non-cellulose polymer (ii to vii) is:
a mixture of Plastistrength® L1000 (ii) (Arkema) and Vinnex® 2526 (iii) (Wacker Chemie) in ex. 1 and ex. 6;
a mixture of Plastistrength® L1000 and Plastistrength® 566 (ii) (5/15) in ex. 2;
Ingeo™ 4060 (v) (NatureWorks) in ex. 3;
Elastollan® 785 A (vii) (BASF) in ex. 4;
Levamelt® 700 (iii) (Lanxess) in ex. 5;
a mixture of Dynacoll® S (v) (Evonik) and Orgasol 3502® (vi) (Arkema) in ex. 7;
a mixture of Elastollan® 780D and Elastollan® 785A (vii) (65/20) in ex. 8;
a mixture of Kane Ace™ PA 211 (ii) (Kaneka) and Ingeo™ 4060 (v) in ex. 9;
Kane Ace™ PA 211 (ii) (Kaneka) for ex. 10, ex. 12 and ex. 13.
a mixture of Plastistrength® L1000 (ii) (Arkema) and Elastollan® 785A (vii) for ex. 11.

The flame retardant used in polymer blend A is:
Fyrolflex® RDP (ICL-IP) in ex. 1, ex. 2, ex. 6, and ex. 9
Disflamoll® TOF (Lanxess) in ex. 3, ex. 4 and ex 10.

The plasticizer used in polymer blend A is:

### Dioctyladipate in ex 1 and ex. 2.

### Grinsted® Soft and Safe (Danisco) in ex. 3, ex. 4, ex. 6, ex. 7 and ex. 10

### Citrofol BII (Jungbunzlauer) in ex. 8 and ex. 9.

The lubricant used in ex. 1 and ex. 2 of polymer blend A is Licolub WE 40 powder (Clariant)

1. A surface covering comprising at least one polymer layer comprising a blend of polymers (A), said blend of polymers comprising from 6.5 to 93.5% by weight of one or more cellulose ester(s) (i) and from 93.5 to 6.5% by weight of one or more polymers selected from the group consisting of (meth)acrylate comprising (co)polymers (ii), vinyl alkanoate comprising (co)polymers (iii), vinylacetals (co)polymers (iv), (co)polyesters (v), (co)polyamides (vi) polyurethanes (vii), nitrile (co)polymers (viii), styrene (co)polymers (ix), vinylchloride (co)polymers (x), olefin (co)polymers (xi), and ionomers (xii).

2. The surface covering according to claim 1, wherein the one or more cellulose ester(s) (i) of the polymer blend (A) comprises:
a plurality of C2-C5 alkanoyl substituents and
a plurality of hydroxyl substituents
wherein the degree of substitution of the hydroxyl substituents is in the range of from 0.3 to 1.0.

3. The surface covering according to claim 1, wherein the one or more cellulose ester(s) (i) of polymer blend (A) are selected from the group consisting of cellulose acetate, cellulose propionate, cellulose butyrate, cellulose acetate propionate, cellulose acetate butyrate and cellulose propionate butyrate.

4. The surface covering according to claim 1, wherein the (meth)acrylate comprising polymers (ii) of the polymer blend (A) are selected from the group consisting of:
(ii.a) the (meth)acrylate homo- or a random (co)polymer comprising at least 60% by weight of methyl (meth)acrylate;
(ii.b) the (meth)acrylate copolymer is a block copolymer comprising one or more blocks of methacrylic ester units and one or more blocks of acrylic ester units;
(ii.c) the alkene/(meth)acrylate copolymer comprising from 50 to 95% by weight of one or more alkenes and from 5 to 50% by weight of one or more C1-C8 alkyl (meth)acrylates;
(ii.d) the alkene/alkyl(meth)acrylate/carbon monoxide copolymers comprising from 40 to 80% by weight of one or more alkenes and from 5 to 60% by weight of one or more C1-C8 alkyl (meth)acrylates and 3 to 30% by weight of carbon monoxide; and
(ii.e) mixtures of (ii.a), (ii.b), (ii.c) and (ii.d).

5. The surface covering according to claim 1, wherein the vinyl alkanoate comprising polymers (iii) of the polymer blend (A) are selected from the group consisting of:
(iii.a) the vinyl alkanoate homo- or copolymers comprising 60% by weight or more of vinyl acetate;
(iii.b) the alkene/vinyl alkanoate copolymers comprising 60% by weight or more of vinyl alkanoate;
(iii.c) the alkene/vinyl alkanoate/carbon monoxide copolymer comprising 40 to 80% by weight of one or more alkenes, 5 to 60% by weight of one or more vinyl alkanoates and 3 to 30% by weight of carbon monoxide; and
(iii.d) mixtures of (iii.a), (iii.b) and (iii.c).

6. The surface covering according to claim 1, wherein the polyester (v) is polylactic acid.

7. The surface covering according to claim 1, wherein the vinylacetal (co)polymer (iv) is polyvinylbutyral.

8. The surface covering according to claim 1, wherein the (co)polyamide (vi) is an aliphatic polyamide.

9. The surface covering according to claim 1, wherein the thermoplastic polyurethane (vii) is an aliphatic thermoplastic polyurethane comprising polyether and/or polyester segments.

10. The surface covering according to claim 1, wherein the polymer layer, comprising polymer blend (A), comprises up to 100 parts by weight of one or more plasticizers selected from the group consisting of dialkyl esters of cyclohexane dicarboxylic acids; dialkyl esters of aliphatic dicarboxylic acids; alkyl esters of mono- di-, tri-, or tetra-carboxylic acids; lower alkyl phosphates; lower alkyl-aryl phosphates; aryl phosphates; alkyl sulfonates; epoxidized or otherwise derivatized vegetable oils, citrate-based plasticizers and acetylated monoglycerides, for 100 parts by weight of polymer blend (A).

11. The surface covering according to claim 1, wherein the polymer layer, comprising polymer blend (A), comprises from 0.01 to 3 parts by weight of an antioxidant, said antioxidant being a hindered phenol type antioxidant alone or a mixture of a hindered phenol type antioxidant and a phosphite type antioxidant, for 100 parts by weight of the polymer blend (A).

12. The surface covering according to claim 1, wherein the polymer layer, comprising polymer blend (A), comprises from 0.01 to 3 parts by weight of one or more light stabilizers selected from the group consisting of benzophenones, benzotriazoles, hydroxyphenyltriazines, cyanoacrylates, oxanilides and hindred amines.

13. The surface covering according to claim 1, wherein the polymer layer, comprising polymer blend (A), comprises from 0.2 to 40 parts by weight of one or more flame retardants selected from the group consisting of phosphorus comprising organic and inorganic flame retardants, halogenated flame retardants, halogenated phosphorus comprising organic flame retardants and mineral flame retardants, for 100 parts by weight of the polymer blend (A).

14. The surface covering according to claim 1, wherein the polymer layer, comprising polymer blend (A), comprises up to 300 parts by weight of one or more organic and/or inorganic fillers selected from the group consisting of coal fly ash, carbonate salts, magnesium carbonate, magnesium oxide, calcium carbonate and calcium-magnesium carbonate, barium sulfate, calcium sulfate, magnesium sulfate, carbon black, metal oxides, inorganic material, natural material, alumina trihydrate, magnesium hydroxide, bauxite, talc, mica, dolomite, barite, kaolin, silica, post-consumer glass, or post-industrial glass, synthetic and natural fiber, for 100 parts by weight of the polymer blend (A).

15. The surface covering according to claim 1, wherein the polymer layer, comprising polymer blend (A), comprises up to 10 parts by weight of one or more lubricants selected from the group consisting of a stearic acid type lubricant, a fatty acid ester type lubricant, a fatty acid amide type lubricant, a paraffin hydrocarbon type lubricant, a naphtenic hydrocarbon type lubricant, a metal soap type lubricant, a silicone type lubricant, a polyethylene glycol type lubricant and waxes, for 100 parts by weight of the polymer blend (A).

16. The surface covering according to claim 1 comprising either:
a wear layer forming the top layer;
a printed layer in contact with the bottom surface of the wear layer;
a core layer in contact with the bottom surface of the printed layer; and
a backing layer in contact with the bottom surface of the core layer;
wherein at least one of said backing layer, said core layer, said printed layer and said wear layer comprises polymer blend (A).
or
a wear layer forming the top layer;
a printed layer in contact with the bottom surface of the wear layer; and
a core layer in contact with the bottom surface of the printed layer;
wherein at least one of said core layer, said printed layer and said wear layer comprises polymer blend (A).

17. The surface covering according to claim 16, wherein the wear layer comprises polymer blend (A)

18. The surface covering according claim 1, wherein at least one of the at least one polymer layer comprises a glass-fiber mat or a non-woven characterized by an air permeability greater than 3000 l/m²·s.

19. The surface covering according to claim 1, comprising at least one other layer that comprises one or more polymers selected from the group consisting of polyvinylchloride, copolymers of vinylchloride and other ethylenically unsaturated monomers, polylactic acid, polyvinylbutyral, styrenic copolymers, polystyrene, polyalkyleneterephthalate, polyalkylenenaphthalate, copolyamide, polyurethane, -polyolefin homopolymers, polyolefin copolymers and block copolymers comprising polymer blocks of one or more vinyl aromatic monomer(s) and polymer blocks of one or more alkylene(s).

20. A method for the preparation of the surface covering according to claim 1, using a process selected from the group consisting of calendaring, flat die extrusion, blown extrusion, heat press and combinations thereof.

21. The surface covering as claimed in claim 1, wherein the surface coveting is one of a floor covering and a wall covering.
